(19) United States
(12) Patent Application Publication
(10) Pub. No.: US 2021/0026853 A1
(43) Pub. Date: Jan. 28, 2021

(54) COMBINATION SEARCH SYSTEM, INFORMATION PROCESSING DEVICE, METHOD, AND PROGRAM

(71) Applicant: NEC Corporation, Tokyo (JP)

(72) Inventors: Ryohto SAWADA, Tokyojp (JP); Masahiko ISHIDA, Tokyo (JP); Yuma IWASAKI, Tokyo (JP)

(73) Assignee: NEC Corporation, Tokyo (JP)

(21) Appl. No.: 17/040,085

(22) PCT Filed: Feb. 15, 2019
(86) PCT No.: PCT/JP2019/005656

§ 371 Date: Sep. 22, 2020

(30) Foreign Application Priority Data
Mar. 23, 2018 (JP) 2018-055494

(51) Int. Cl. G06F 16/2453; G06F 16/28; G06F 16/22; G06N 7/00

(52) U.S. Cl. CPC G06F 16/24542; G06F 16/283; G06F 30/20; G06N 7/005; G06F 16/2264

(57) ABSTRACT

A combination search system includes: a storage that stores actual data in which input information indicating a combination of values taken by elements of the multi dimensions in the confirmation work in the past or in a real space is associated with output information indicating a value of the predetermined parameter obtained for the combination indicated by the input information at that time; and a search unit that repeats, a process of determining at least one combination to be used in next confirmation work on the basis of importance of information that is an index defined for each combination of the elements, the index being calculated from the actual data and being based on an amount of change in uncertainty of the value of the predetermined parameter in a whole of a search space due to that new output information for the combination is added to the actual data.

### TECHNICAL FIELD

The present invention relates to a combination search system, an information processing device, a combination search method, and a combination search program that search for a multidimensional combination that optimizes a predetermined parameter.

### BACKGROUND ART

For speeding up and cost reduction of material development, there is a demand for a technique for searching for a material having an excellent characteristic with a small number of experiments. However, most of materials having such an excellent characteristic include a combination of a plurality of elements, and generation conditions are diverse, such as a composition ratio in a material of a multi-component alloy. Optimization of generation conditions for such materials is a multidimensional combination problem. In the multidimensional combination problem, the number of patterns that the combination can take increases exponentially with the number of conditions (for example, in the case of the composition ratio of the multi-component alloy, the number of elements that can be synthesized). For that reason, optimization is difficult only by human prediction such as experience and intuition, and a mathematical approach is important.

With the recent development of computer technology, it has become possible to predict a physical quantity with a certain degree of accuracy by using first-principles calculation or molecular dynamics without actually making a material. However, for example, when a problem is considered of optimizing a composition ratio of a material of a quaternary alloy with an accuracy of about 1%, the number of patterns of combinations is about 100 million. In such a multidimensional combination problem, even if the physical quantity desired to be optimized can be predicted by using a calculation method, it is difficult to perform a full search.

As one of methods for optimizing the multidimensional combination problem, it can be considered to narrow down candidates for experimental conditions by learning a correlation between the experimental conditions and a characteristic to be optimized on the basis of past experimental results, and predicting what kind of characteristic is obtained for an arbitrary condition. In the above example, an efficient material search becomes possible by learning a correlation between the composition ratio of the material of the multi-component alloy that is the experimental condition and a physical characteristic (magnetism, thermoelectric characteristic, or the like) obtained under the experimental conditions, predicting what kind of characteristic is obtained at a composition ratio at which the characteristic is unknown, and limiting a next experimental condition to a combination (composition ratio) in which a suitable result is obtained.

As a method for learning the correlation, attention has been paid to a mathematical method used in machine learning technology or Artificial Intelligence (AI).

An example of a method for optimizing a combination problem using a mathematical method is described in NPL 1 and PTLs 1, 2, and 3, for example.

For example, NPL 1 describes an optimization method by Gaussian process regression and expectation maximization. In addition, PTL 1 describes an optimization method using a Monte Carlo method. In addition, PTL 2 describes a method based on a particle swarm optimization method. In addition, PTL 3 describes an optimization method by minimizing an index of interest of a stochastic system.

In addition, for example, as an example of a method for optimizing a multidimensional combination problem involving experiments, NPL 2 describes a method for giving a combination to be measured next by expressing a combination as a gene, weeding out those with poor experimental results, and crossing excellent genes.

### CITATION LIST

### Patent Literature

PTL 1: Japanese Patent Application Laid-Open No. 2009-146072

PTL 2: International Publication No. 2013/008345

PTL 3: International Publication No. 2016/194051

### Non Patent Literature

NPL 1: Kazuo Ishii, “Translation Materials Informatics Search and Design”, 2017, p. 43-69

NPL 2: D. M. Deaven and K. M. Ho, “Molecular Geometry Optimization with a Genetic Algorithm”, Phys. Rev. Lett. 75, July 1995.

### SUMMARY OF INVENTION

### Technical Problem

For example, optimization is considered of a composition ratio of a multidimensional material with respect to a desired characteristic by using the method described in each of the above documents.

In optimization of the composition ratio, two things are mainly required. That is, (1) to determine at high speed which combination should be preferentially measured, and (2) even when a characteristic to be optimized have peaks in a plurality of different combinations, combinations corresponding to a plurality of peaks are obtained.

Regarding the above (1), for example, the method described in NPL 1 calculates a priority for all combinations whose results are unknown by using a function indicating a relationship between a variance and an expected value obtained by Gaussian process regression, and determines a combination with the highest priority as a next experimental candidate. However, in a multidimensional system in which the number of combinations is huge, it is difficult to calculate the priority for all combinations.

In addition, the method described in PTL 1 uses a regression tree to achieve speeding up, but there is no change in that the design and calculation cost of the regression tree depends on an exponential function of the number of conditions, and in addition, a method for solving that is not considered at all.

In addition, the method described in PTL 2 achieves speeding up by modeling swarm intelligence of insects and fish. Specifically, a plurality of agents is arranged in a multidimensional space spanned by a multidimensional vector depending on the number of conditions for combination, and an experiment is conducted at each of positions of those agents. A process is repeated of moving another agent in a direction in which an agent that has obtained an excellent characteristic exists, as a result of the experiment. As a result, search for a combination having an excellent characteristic is speeded up. However, while this method is fast, it is difficult to explicitly deal with duplication of agents, and there is a problem that efficiency drops significantly when the agents concentrate on a specific combination.

In addition, the method described in PTL 3, a gradient of a characteristic in the multidimensional space is estimated from past experimental results, priority is calculated by performing narrowing down to a combination that is more likely to improve the characteristic, and searching is performed for an optimal solution on the basis of the obtained priority. However, although this method achieves speeding up by narrowing down the combinations for calculating the priority, it is difficult to get out of a local solution by a simple hill-climbing method that estimates the gradient and climbs to a peak.

The method described in NPL 2 performs combination optimization by giving a combination to be measured next by expressing a combination as a gene, weeding out those with poor experimental results, and crossing excellent genes. This method is also called a genetic algorithm and has a wide range of applicable problems, and calculation cost of determining a combination is fast regardless of the dimension of the problem. However, this method has a problem that since the ones with poor experimental results are weeded out, it is difficult to manage the diversity of combinations, the search range is narrowed, and the method easily falls into a local solution. In addition, the method described in NPL 2 has a problem that duplication of the combination cannot be managed and the experiment cost increases. Note that, it is possible to manage the diversity of combinations by obtaining a predicted value and a variance for each combination by using the method described in NPL 1, but there is a problem that since a sufficient number of genes are required for performing crossing even for combinations with small variances, calculation efficiency is not so high, calculation cost of regression is high, and high speed of the genetic algorithm is impaired.

Regarding the above (2), in an optimization problem of multidimensional combination, a combination other than a combination that shows the most excellent result may be required. For example, in the case of an optimization problem of the composition ratio of the multidimensional material, there is a case where it is desired to use a low-cost and harmless material due to an influence such as cost of the material and environmental consideration, even if the characteristic is sacrificed to some extent. In addition, simply, there may be a case where there is a plurality of combinations that shows an excellent result of about the same degree.

However, each of the above methods is a method for searching for a combination having the most excellent characteristic, and searching for other combinations having an excellent characteristic at high speed (for example, more efficiently than the full search) is not considered.

The present invention has been made in view of the problems described above, and aims to provide a combination search system, an information processing device, a combination search method, and a combination search program that can search for an appropriate solution efficiently and stably even in the case of having a plurality of peaks in a multidimensional combination problem of optimizing a predetermined parameter.

### Solution to Problem

A combination search system according to the present invention includes: a storage that stores information that is actual data in a multidimensional combination problem for a predetermined parameter accompanied by predetermined confirmation work and in which input information indicating a combination of values taken by elements of the multi dimensions in the confirmation work or in a real space in the past is associated with output information indicating a value of the predetermined parameter obtained for the combination indicated by the input information at that time; and a search unit that repeats, until a predetermined end condition is satisfied, a process of determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

In addition, an information processing device according to the present invention is an information processing device accessible to a storage that stores information that is actual data in a multidimensional combination problem for a predetermined parameter accompanied by predetermined confirmation work and in which input information indicating a combination of values taken by elements of the multi dimensions in the past in the confirmation work or in a real space is associated with output information indicating a value of the predetermined parameter obtained for the combination indicated by the input information at that time, the information processing device including a search unit that repeats, until a predetermined end condition is satisfied, a process of determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

In addition, a combination search method according to the present invention repeating a process by an information processing device until a predetermined end condition is satisfied, the information processing device being accessible to a storage that stores information that is actual data in a multidimensional combination problem for a predetermined parameter accompanied by predetermined confirmation work and in which input information indicating a combination of values taken by elements of the multi dimensions in the past in the confirmation work or in a real space is associated with output information indicating a value of the predetermined parameter obtained for the combination indicated by the input information at that time, the process determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

In addition, a combination search program according to the present invention causes a computer to execute a process repeatedly until a predetermined end condition is satisfied, the computer being accessible to a storage that stores information that is actual data in a multidimensional combination problem for a predetermined parameter accompanied by predetermined confirmation work and in which input information indicating a combination of values taken by elements of the multi dimensions in the past in the confirmation work or in a real space is associated with output information indicating a value of the predetermined parameter obtained for the combination indicated by the input information at that time, the process determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

### Advantageous Effects of Invention

According to the present invention, it is possible to efficiently and stably search for an appropriate solution even in the case of having a plurality of peaks in a multidimensional combination problem of optimizing a predetermined parameter.

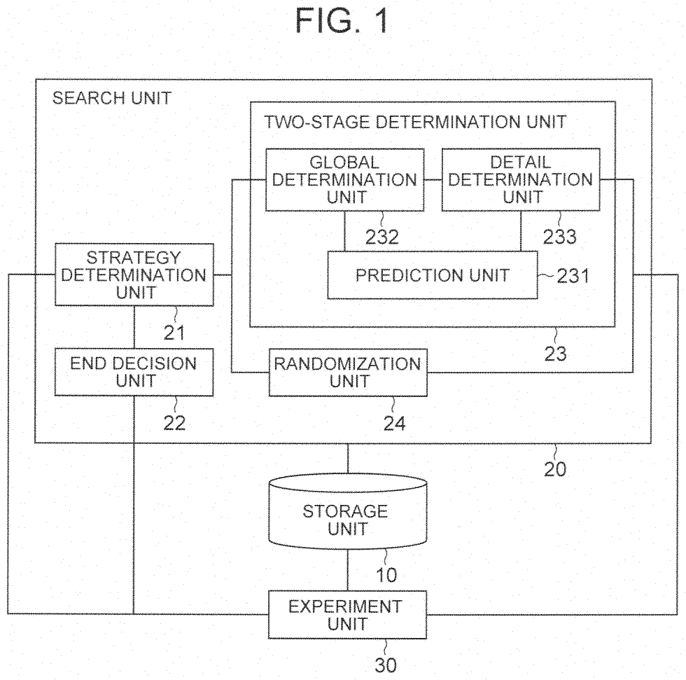

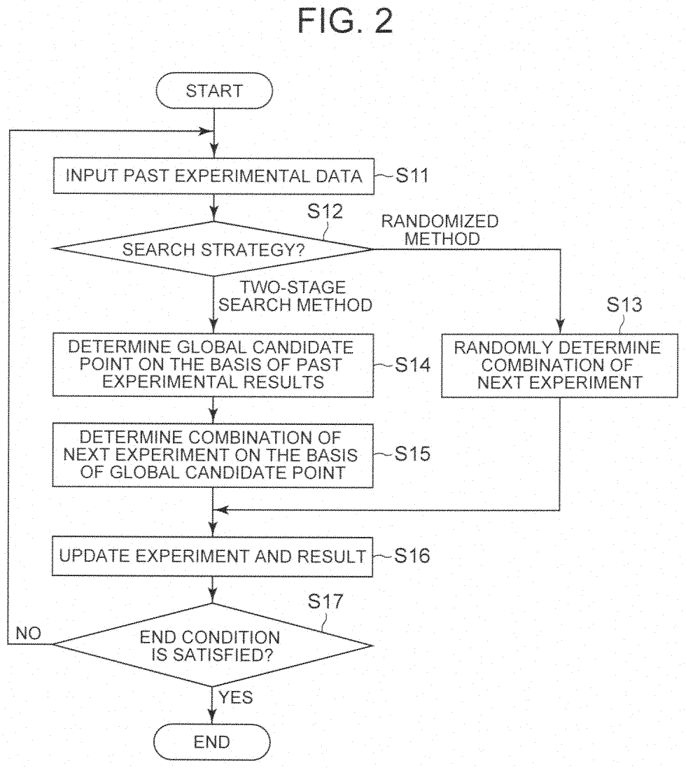

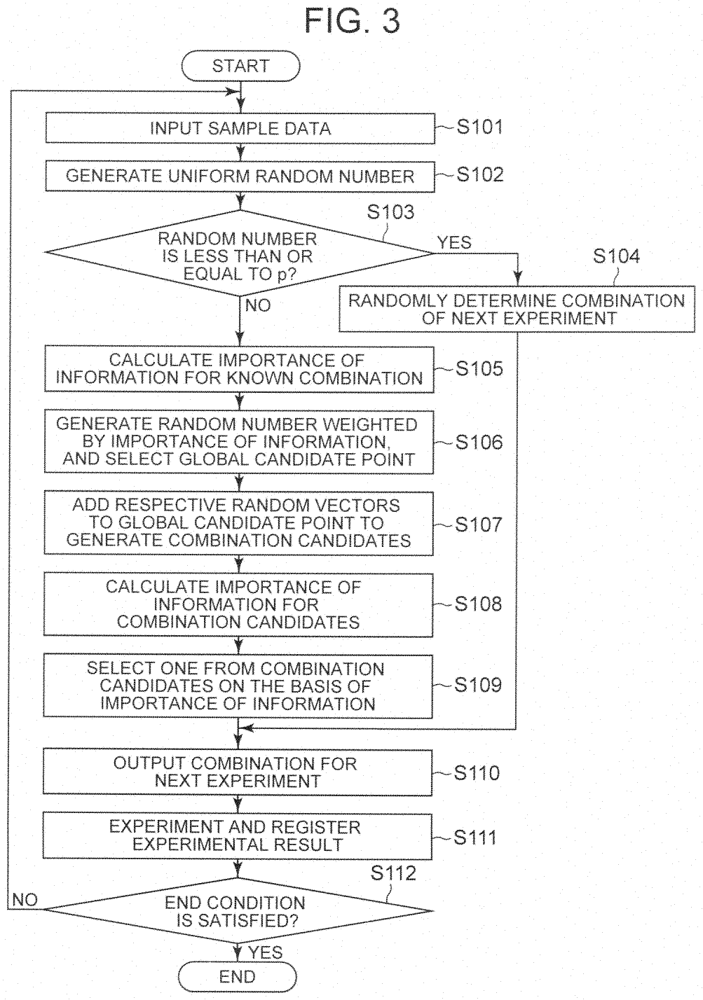

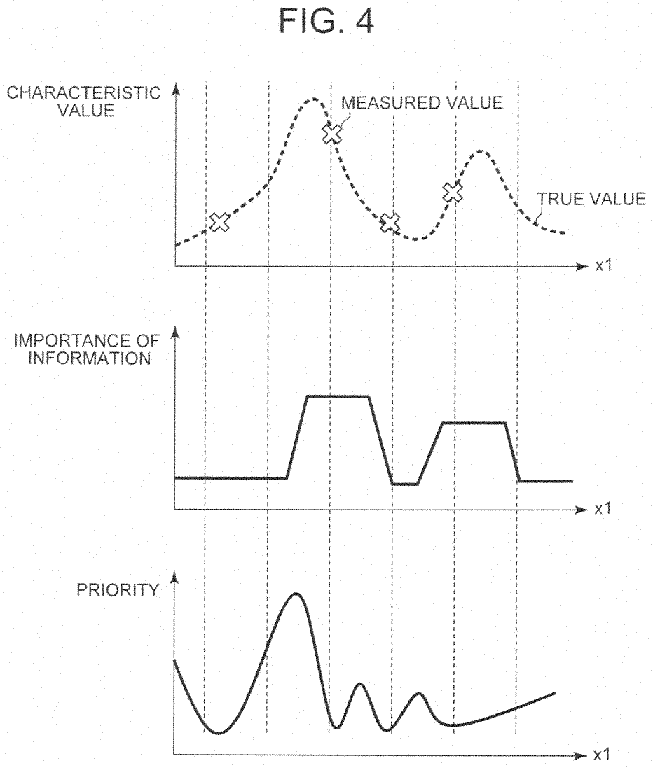

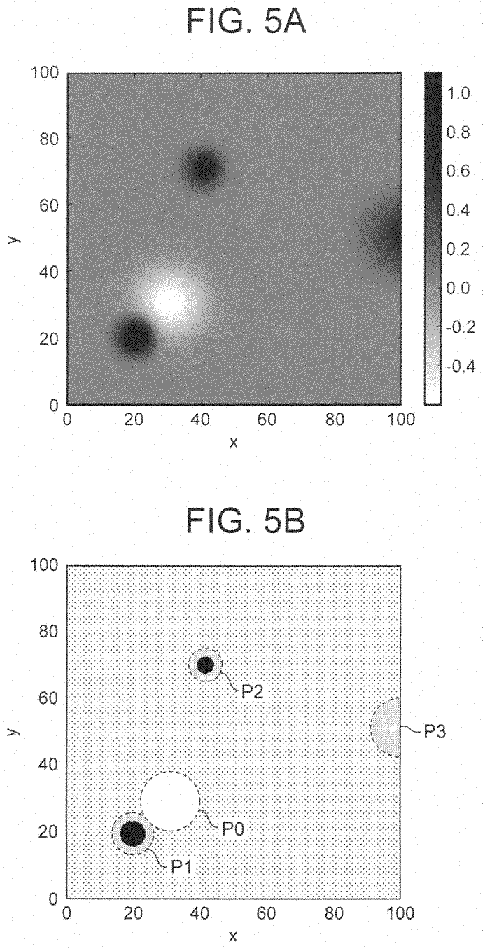

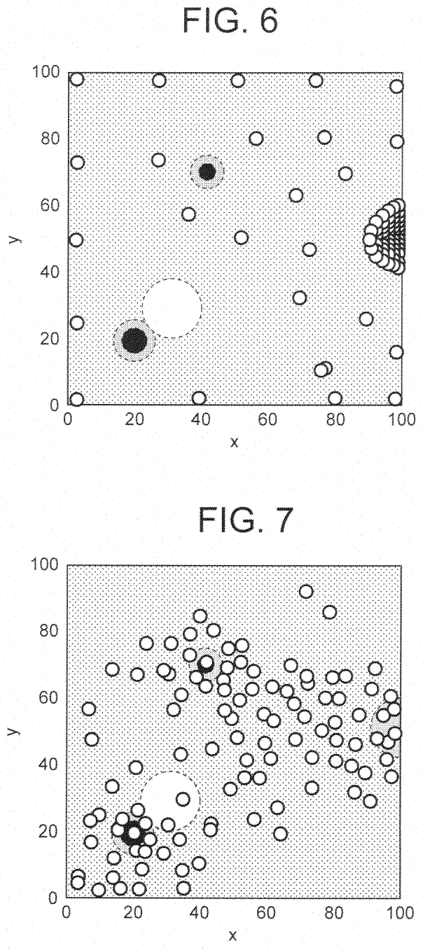

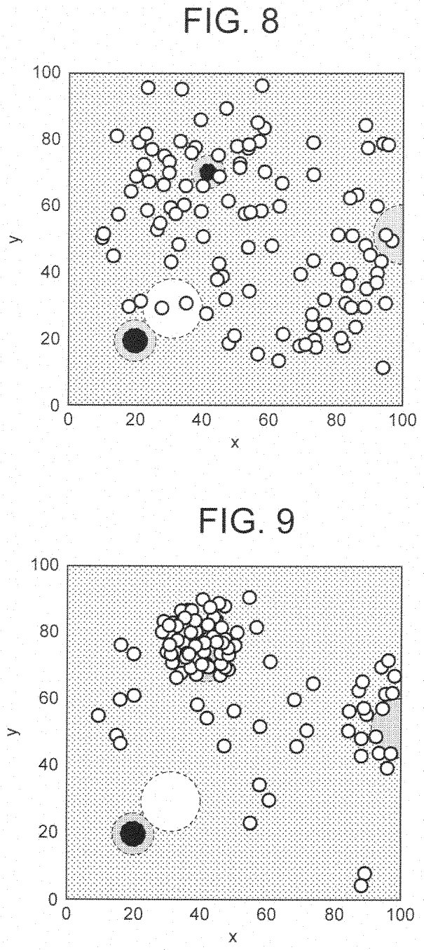

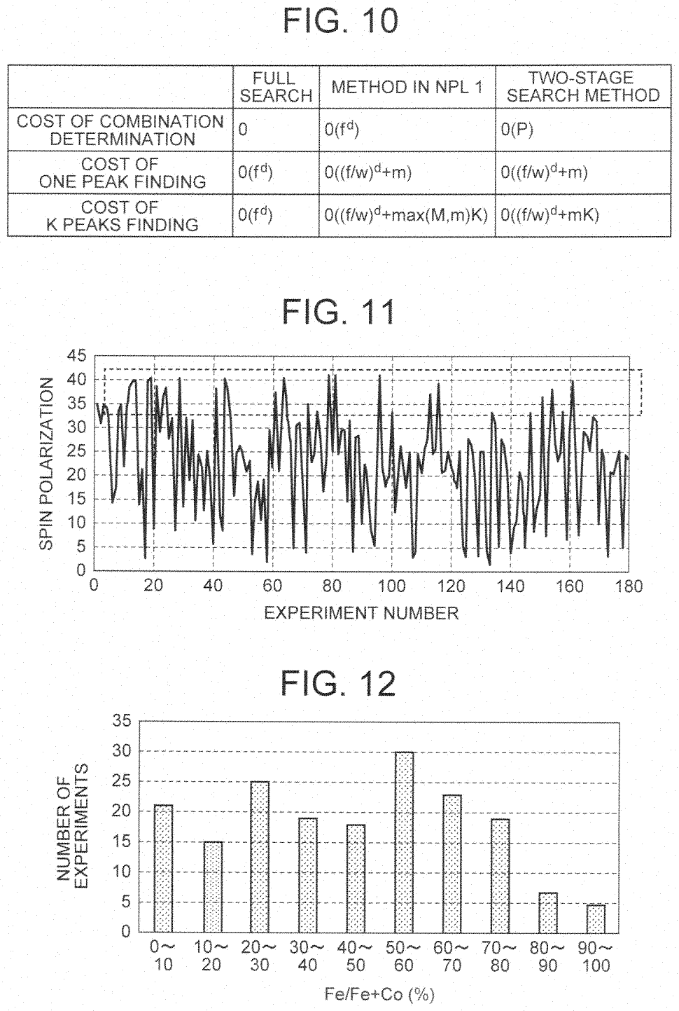

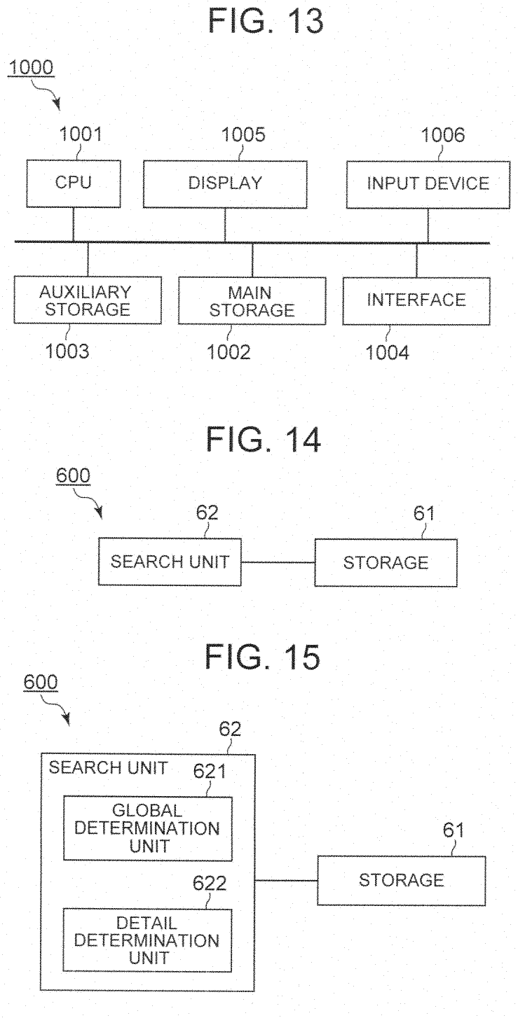

### BRIEF DESCRIPTION OF DRAWINGS

[FIG. 1] It depicts a block diagram illustrating a configuration example of a combination search system according to a first exemplary embodiment.

[FIG. 2] It depicts a flowchart illustrating an operation example of the combination search system of the first exemplary embodiment.

[FIG. 3] It depicts a flowchart illustrating a more detailed operation example of the combination search system of the first exemplary embodiment.

[FIG. 4] It depicts an explanatory diagram illustrating an example of importance of information for a one-dimensional function.

[FIG. 5A] It depicts a graph illustrating output of a function F(x, y) of an optimization problem of a binary combination that is a first example.

[FIG. 5B] It depicts a graph illustrating output of a function F(x, y) of an optimization problem of a binary combination that is a first example.

[FIG. 6] It depicts a schematic diagram illustrating an example of search results of a combination of parameters x and y for the function F.

[FIG. 7] It depicts a schematic diagram illustrating an example of the search results of the combination of the parameters x and y for the function F.

[FIG. 8] It depicts a schematic diagram illustrating an example of the search results of the combination of the parameters x and y for the function F.

[FIG. 9] It depicts a schematic diagram illustrating an example of the search results of the combination of the parameters x and y for the function F.

[FIG. 10] It depicts an explanatory diagram illustrating a result of cost comparison between the two-stage search method according to the present invention and other methods.

[FIG. 11] It depicts a graph illustrating an experimental result in a second example.

[FIG. 12] It depicts a graph illustrating a distribution of the number of experiments for each synthesis ratio of Fe in the second example.

[FIG. 13] It depicts a schematic block diagram illustrating a configuration example of a computer according to each exemplary embodiment of the present invention.

[FIG. 14] It depicts a block diagram illustrating an outline of a combination search system of the present invention.

[FIG. 15] It depicts a block diagram illustrating another example of the combination search system of the present invention.

### DESCRIPTION OF EMBODIMENTS

### First Exemplary Embodiment

Hereinafter, an exemplary embodiment of the present invention will be described with reference to the drawings. FIG. 1 is a block diagram illustrating a configuration example of a combination search system according to a first exemplary embodiment. The combination search system illustrated in FIG. 1 includes a storage unit 10, a search unit 20, and an experiment unit 30.

The storage unit 10 stores information (actual data) indicating a result of an experiment regarding a characteristic to be optimized, the experiment being performed for each of one or more combinations of the composition ratio of the multidimensional material. The storage unit 10 stores at least one piece of information in which information on a material for which the experiment is performed (composition ratio of the multidimensional material) is associated with a characteristic obtained by the experiment from the material. Hereinafter, the composition ratio of the multidimensional material of the material used in the experiment may be referred to as experimental input information or simply input, and the characteristic obtained by the experiment from the material may be referred to as experimental output information or simply output.

The search unit 20 repeatedly performs, until the experimental result or a search result satisfies a predetermined end condition, a search determination process of searching for and determining one combination for which the experiment is performed next from a search space that is a multidimensional space spanned by a multidimensional vector including components corresponding conditions (elements) to be combined.

The search unit 20 of the present exemplary embodiment includes a strategy determination unit 21, an end decision unit 22, a two-stage determination unit 23, and a randomization unit 24. Note that, the search unit 20 repeatedly performs the search determination process by the two-stage determination unit 23 or the randomization unit 24 depending on a search strategy determined by the strategy determination unit 21 until it is decided that a predetermined end condition is satisfied in the end decision unit 22.

The strategy determination unit 21 determines a peak search strategy. In an example described below, as the peak search strategy, either of a two-stage search method described below or a randomized method which randomly selects a combination is determined. However, the strategy determination unit 21 can be omitted in a case where the experimental results for a plurality of combinations with appropriate variations are obtained, or the like. Alternatively, the strategy determination unit 21 may be replaced with a random determination machine (not illustrated) that first randomly determines a combination several times. Note that, when the strategy determination unit 21 is omitted or replaced with the random determination machine, the randomization unit 24 is also omitted.

The end decision unit 22 decides whether or not the search satisfies the end condition on the basis of the progress of the search and the experimental results so far, and ends the search determination process in the search unit 20 when the end condition is satisfied.

Note that, in the present exemplary embodiment, each time one combination for which the experiment is performed next is determined in one search determination process, the experiment is performed by the experiment unit 30 described later, and the result is added to the storage unit 10. The added experimental result is referenced as one of the experimental results so far in the next search determination process.

The two-stage determination unit 23 and the randomization unit 24 each are a determination machine that determine the input in a next experiment, on the basis of the information in the storage unit 10 that holds the input and the output in the past experiment. However, the two-stage determination unit 23 determines the input in the next experiment by using the two-stage search method, and the randomization unit 24 determines the input in the next experiment by using the randomized method.

Note that, in the present exemplary embodiment, an experiment is exemplified as a method of acquiring actual data, but it is sufficient that the actual data is obtained by predetermined confirmation work. Besides the experiment, examples of the confirmation work include numerical calculation (calculation simulator or the like) or the like that satisfies a predetermined accuracy. In addition, the experiment includes various verification operations such as causing an event or the like indicated by the combination to occur in the real space or its pseudo space and acquiring the phenomenon occurring at that time. Thus, the experiment unit 30 described above can be replaced with various devices for performing the predetermined confirmation work. In that case, the input in the next experiment is only required to be replaced with the input used in next confirmation work. In addition, it is also possible to add, to the input, a discrete parameter, or one on which pre-processing such as dimension compression is performed. Specific examples of the input and the output are listed below.
A composition ratio (input) of a material of an alloy, and a physical characteristic (output) such as magnetism, electricity, or heat of the alloy
A composition ratio (input) of a material of an alloy, and a predicted value (output) by simulation of a physical characteristic such as magnetism, electricity, or heat of the alloy
A shape (input) of a material, and a physical characteristic (output) such as heat or magnetism of the material obtained from calculation simulation
A shape (input) of a material, and a predicted value (output) by simulation of a physical characteristic (output) such as heat or magnetism of the material obtained from calculation simulation
Image information (input) and electrical characteristics (output) of a circuit subjected to dimension reduction by a method such as t-distributed stochastic neighbor embedding (t-SNE).
Various combinations and their values in combination problems, such as a combination (input) of goods, and a value (output) of the goods in a knapsack problem

The two-stage determination unit 23 includes a prediction unit 231, a global determination unit 232, and a detail determination unit 233.

The prediction unit 231 predicts a value (output) of a characteristic to be optimized for an arbitrary combination (input) on the basis of the information stored in the storage unit 10. The prediction unit 231 can use a known method such as kernel approximation or Gaussian process regression. In addition, it is also possible to use an estimation model learned by a known learning method used for machine learning technology or AI.

The global determination unit 232 globally determines a search starting point of the input (combination) in the next experiment on the basis of past experimental results and a prediction result by the prediction unit 231. Hereinafter, the search starting point determined by the global determination unit 232 may be referred to as a global candidate point.

When determining the global candidate point, the global determination unit 232 obtains importance of information for each input (combination) from the past experimental results, and uses the importance of information. As a result, the global candidate point is determined at high speed (at least at a lower calculation cost than brute force calculation).

In the present exemplary embodiment, as the importance of information for each combination, an index is used based on at least “a reduction degree of uncertainty of a value in the search space due to that the number of experiments is increased, that is, the number of measurements of the value (in the case of the present example, a predetermined characteristic value) of a predetermined parameter for the combination is increased, the reduction degree being predicted from the past experimental results”. Here, the uncertainty of the value of the predetermined parameter may be uncertainty (Error) for an expected value that is given by an arbitrary prediction function and is created from an error of an experimental value. More specifically, it may be uncertainty of a predicted value of the output obtained by performing regression analysis such as kernel approximation or Gaussian process regression on the inputs and the outputs used in the past experiments.

For example, importance of information for a certain combination may be an index that monotonically increases or an index that has a positive correlation with respect to the “reduction degree” indicating how much the uncertainty for the expected value obtained by regression from the past experimental results is reduced by adding measurement of the combination. In addition, the importance of information for a certain combination may be an index based on the value (expected value) of the predetermined parameter for the combination predicted from the past experimental results, and the reduction degree of the uncertainty of the value (expected value) of the predetermined parameter for the combination predicted from the past experimental results when the measurement for the combination is added. By adding the expected value, it is possible to perform adjustment such as reducing the importance of a combination for which an excellent characteristic is unlikely to be obtained.

Here, as an index indicating the uncertainty of the predicted value in the search space, a variance (or a sum total thereof) may be used. In that case, the importance of information may be a value based on a reduction degree of the variance (or the sum total thereof) of the value (expected value) of the predetermined parameter in the search space due to that the number of experiments for the combination is increased, the reduction degree being predicted from the past experimental results. Note that, “importance of information” in the present exemplary embodiment can also be regarded as “investment priority” for the experiment. In addition to the variance, an index may be used that is obtained by multiplying the expected value for the combination and the uncertainty, obtained from the past experimental results. By using the multiplication of the expected value and the uncertainty, it is possible to reduce the importance for a point at which the uncertainty is low and a point at which the expected value is low in the search space.

The global determination unit 232 may determine the global candidate point by obtaining importance of information with a decrease value of the sum total of errors in the whole of the search space as an index for each input measured in the past, for example, and adopting one of the inputs subjected to the experiment in the past with a probability proportional to the importance of information.

The detail determination unit 233 determines one combination as an experimental candidate next on the basis of the global candidate point determined by the global determination unit 232.

The detail determination unit 233 may determine the one combination as the experimental candidate next by, for example, a local optimization method with the global candidate point as a starting point. As a specific example, the detail determination unit 233 may generate a plurality of candidates for the combination to be subjected to the experiment next by adding random noise to the combination determined as the global candidate point, and adopt from the candidates a candidate whose importance of information is the highest as the next combination. In addition, for example, the detail determination unit 233 may obtain a local optimal solution by using a hill-climbing method or the like with the global candidate point as the starting point, and use it as the next combination. At this time, the detail determination unit 233 can use an index (for example, a predicted value) other than the importance of information.

In the present exemplary embodiment, such a method, in which first, one combination is obtained as a search starting point of the next combination at high speed and globally on the basis of the actual data, and then an optimal solution is obtained locally on the basis of the one combination obtained globally, is referred to as the two-stage search method. In particular, when one combination is obtained globally or when a local optimal solution is obtained, importance of information for each combination is acquired from data in the past quantitatively and by limiting the calculation target, whereby a combination having a high possibility that a better output is obtained is inferred at high speed.

The experiment unit 30 performs the experiment on the combination determined by the search unit 20. Note that, the result of the experiment by the experiment unit 30 is registered (added) in the storage unit 10.

Next, operation of the present exemplary embodiment will be described. FIG. 2 is a flowchart illustrating an operation example of the combination search system of the present exemplary embodiment. The operation illustrated in FIG. 2 is broadly divided into a combination determination phase (step S11 to step S15) of determining a combination (input) of the next experiment, an experiment phase (step S16) of performing the experiment with the determined combination and acquiring the result, and a decision phase (step S17) of deciding the end condition.

In the determination phase, the data of the storage unit 10 is input to the search unit 20, and the search unit 20 determines the input of the next experiment on the basis of the input data. In the experiment phase, the experiment unit 30 performs the experiment on the input determined by the search unit 20, and adds the output of the experiment to the storage unit 10. In the decision phase, it is confirmed whether or not the results so far satisfy the end condition, and when the condition is not satisfied, the data in the storage unit 10 is input to the search unit 20 again, and the process returns to the process of determining the input. The end condition is set by a user of the present system depending on the problem. Examples of the end condition include the fact that the height of the peak (the height of the confirmed characteristic), the number of peaks (the number of combinations to be appropriate solutions), the error (the uncertainty of the predicted value), and the number of experiments have reached predetermined values, and the like. Note that, although not illustrated in FIG. 1, an information processing device or the like including the search unit 20 may further include an output unit that outputs information indicating the input of the next experiment, and an input unit for adding new actual data to the storage unit 10.

Hereinafter, the operation of the present exemplary embodiment including these phases will be described in more detail with reference to FIG. 2. In the example illustrated in FIG. 2, first, the data in the storage unit 10 is input to the search unit 20, and a determination instruction is given for a combination to be a next experiment target (step S11).

When the determination instruction is given for the combination to be the next experiment target, first, the strategy determination unit 21 determines a peak search strategy in the current search determination process (step S12). The strategy determination unit 21 may determine whether to use the two-stage search method or the randomized method as the peak search strategy, for example.

When the randomized method is adopted as the peak search strategy, the randomization unit 24 of the search unit 20 randomly generates a combination of the next experiment (step S13). On the other hand, when the two-stage search method is adopted as the peak search strategy, the process proceeds to step S14.

In step S14, the global determination unit 232 globally searches for a combination to be the search starting point of the combination of the next experiment on the basis of the past experimental results, and determines a global candidate point. Here, “search globally” means to search the whole of a space (search space) spanned by the inputs as a search range. In the above example, searching by using the importance of information as an adoption probability corresponds to “global”.

Then, the detail determination unit 233 locally searches for a candidate for the combination of the next experiment on the basis of the determined global candidate point, and determines one combination (step S15). Here, “search locally” means to search only a part (for example, a neighborhood area from the starting point) of the space (search space) spanned by the inputs as the search range. In the above example, searching by using candidates obtained by adding predetermined random noises to the global candidate point corresponds to “local”.

When the combination of the next experiment is determined, the experiment unit 30 performs the experiment and adds the result to the storage unit 10 (step S16).

Finally, the end decision unit 22 performs end decision (step S17). When the predetermined end condition is satisfied (Yes in step S17), the search determination process is ended. On the other hand, when the predetermined end condition is not satisfied (No in step S17), the process returns to step S11, and the search determination process is performed for determining the combination of the next experiment.

FIG. 3 is a more detailed flowchart of the operation example illustrated in FIG. 2. The combination search system of the present exemplary embodiment may perform the operation as illustrated in FIG. 3, for example.

In the example illustrated in FIG. 3, first, the experimental result stored in the storage unit 10 is input to the search unit 20 as sample data, and the determination instruction is given for the combination to be the next experiment target (step S101). Note that, initially, the number of experimental results may be one or zero. Note that, in the case of zero, the processes of steps S102 to S103 may be skipped and the process is only required to proceed to step S104.

When the determination instruction is given, the strategy determination unit 21 generates a uniform random number (step S102). Then, when the generated random number is less than or equal to a specific value p (step S103), the process proceeds to step S104, and otherwise, the process proceeds to step S105. Note that, step S104 corresponds to the search determination process by the randomized method described above, and steps S105 to S109 correspond to the search determination process by the two-stage search method described above.

Here, p can take a value of from 0 to 1, and preferably take a value of about 0<p<0.5. As p takes a larger value, the randomized method is more likely to be adopted, so that the number of experiments required to find the peak decreases, while the number of experiments required to determine the height of the peak increases. Note that, it is also possible to gradually reduce p like p=0.5(1−n/N). Here, n is the number of experiments performed so far, and N is an upper limit value of the number of experiments determined by the user. By reducing p depending on the number of experiments performed so far, the importance of searching for a new peak can be dynamically changed.

In step S104, the randomization unit 24 randomly generates the combination of the next experiment. Note that, in the randomization unit 24, instead of randomly generating the combination, it is also possible to efficiently search for an unknown combination by preparing a plurality of combinations randomly created, and adopting a combination whose uncertainty A obtained by a method described later is the largest.

Note that, the processes of steps S101 to S104 can be replaced with a means such as first performing experiments with random combinations multiple times as described above.

In steps S105 to S106, the global determination unit 232 determines one combination as the global candidate point on the basis of an expected value E of a measured value that is an objective variable and the uncertainty A, for each combination inferred from the past experiments. In the present example, the global determination unit 232 determines, as the global candidate point, a combination in which more information regarding the peak can be obtained by additionally performing an experiment.

The global determination unit 232 first calculates importance of information for a known combination by using the prediction unit 231 (step S105). Here, the global determination unit 232 uses the prediction unit 231 to infer the expected value E and uncertainty A of the output for the input, from the past experiments. Note that, since it is difficult in terms of calculation cost to calculate the expected value E and uncertainty A for all possible inputs, in the following, the expected value E and uncertainty A are calculated only for the inputs used in the past experiments. Then, the global determination unit 232 globally infers an input having a high possibility that a better output is obtained, by obtaining the importance of information on the basis of the calculated expected value E and uncertainty A.

It is possible to search for a plurality of peaks by using such importance. For example, in the case of a method in which only an input is adopted having a high probability that the maximum value of the output can be updated, that is, simply having high expected value E and uncertainty A, the peak to be searched for is fixed to one peak. On the other hand, the global determination unit 232 prevents the peak to be searched for from being fixed to one peak, by adopting an input that is inferred from the experimental result and in which more information about the peak can be obtained by additionally performing an experiment, that is, an input having a large reduction degree of variation (variance) over the entire range of possible inputs. Note that, it is also possible to obtain the expected value E and the uncertainty A for inputs other than inputs used in the past experiments (for example, some inputs selected from an area in which no experimental results is obtained so far in the search space) within a range allowed by the calculation cost.

The expected value E of an output for an arbitrary input and the uncertainty A are calculated by the prediction unit 231. The prediction unit 231 can use a known method.

For example, when an expected value Eᵢ and uncertainty A, are obtained by kernel regression for an input Xᵢ identified by i in the sample data, the following equation (1) may be used. Here, the sample data refers to a set of data including inputs whose outputs are known. For example, i may be an experiment number. However, this is not the case when Eᵢ and Aᵢ are obtained for the input Xᵢ whose experimental result is unknown. Also in that case, Eᵢ and Aᵢ can be obtained by substituting the input Xᵢ whose experimental result is unknown into the equation (1). Here, X is a multidimensional vector including two or more mutually independent components such as {x1, x2, x3, . . . }.

$$\begin{matrix}[ Mathematical Expression 1 ] & \\ {E}_{i} = \frac{{\sum }_{j} K ( {X}_{i} - {X}_{j} ) {R}_{i}}{{\sum }_{j} K ( {X}_{i} - {X}_{j} )} \\ {A}_{i} = \frac{1}{{\sum }_{j} K ( {X}_{i} - {X}_{j} )} & ( 1 )\end{matrix}$$

Here, Rᵢ is an output (measured value) obtained for Xᵢ. In addition, K is a kernel function. Known kernel functions such as a Gaussian kernel and a polynomial kernel can be used for the kernel function. Xᵢ−Xⱼ that is an input of a kernel function K( ) represents a distance between the input Xᵢ and the input Xⱼ. As the distance, a Euclidean distance, a Manhattan distance, or the like can be used. Here, the input Xⱼ represents any input included in the sample data. Thus, j takes a value between 1 and the number of sample data.

Information importance Zᵢin the input Xᵢ may be given by a function that satisfies that (1) the function converges to 0 when Aᵢ is 0 or Eᵢ is 0, and that (2) Zᵢ≤Zⱼ if Aᵢ≤Aⱼ and Eᵢ≤Eⱼ for arbitrary i, j. Note that, when the predicted value can take a negative value, “0” for Aᵢ in the above condition (1) can be replaced with the minimum value obtained by the experimental results so far.

One of preferable examples of Zᵢ, is “an index having a positive correlation such as showing an increasing tendency, with respect to an increase in the reduction degree of the uncertainty of the predicted value in the entire search space due to that the experiment on the input Xᵢ is additionally performed”. In this case, the importance Zᵢ can be calculated as follows.

When the kernel approximation indicated in the above equation (1) is used, uncertainty U of the predicted value in the search space can be evaluated by the sum total of variances of the sample data. That is, evaluation can be performed by using the following equation (2).

[Mathematical Expression 2]

U=ΣᵢEᵢ*Aᵢ^{3/2} (2)

At this time, a reduction degree Dᵢ of the sum total of variances in the entire search space due to that the experiment is additionally performed on the input Xᵢ is given by the equation (3).

[Mathematical Expression 3]

Dᵢ=Eᵢ*Aᵢ^{5/2} (3)

As the importance of information Zᵢ of the input Xᵢ, Dᵢ may be used as it is, or instead of Dᵢ, it is possible to use the square root of Dᵢ, or the one in which the order of Aᵢ is other than 5/2. Note that, all of these satisfy the above conditions (1) and (2).

FIG. 4 is an explanatory diagram illustrating an example of the information importance for a one-dimensional function. A true value (actual function) for a prediction target (one-dimensional element) is illustrated in the upper column of FIG. 4. Note that, in the upper column of FIG. 4, cross marks represent results obtained in the experiments so far. In addition, the middle of FIG. 4 illustrates an example of the “information importance” obtained in the present exemplary embodiment for the prediction target. In addition, an example of the priority obtained by the method of NPL 1 is illustrated in the lower column of FIG. 4 as a comparative example. As illustrated in the lower column of FIG. 4, the priority is high near the peak on the left side (first peak) where a high characteristic is obtained in the past experiment, and the priority is significantly low near the peak on the right side (that is, second peak), but in the middle of FIG. 4 illustrating the information importance of the present exemplary embodiment, high values are taken in a well-balanced manner near the two peaks.

Note that, when the expected value Eᵢ for the input Xᵢ and the uncertainty Aᵢ are obtained by using Gaussian process regression, Aᵢ=0 is obtained when Gaussian process regression is directly applied to the input Xᵢ. In that case, the prediction unit 231 is only required to perform scanning by adding a minute random number to each component of the input Xᵢ and removing the input Xᵢ from the Gaussian process regression data (sample data). As a result, non-zero Aᵢ can be obtained. Note that, an example of the minute random number is a random number of about 0.02 L to 0.1 L. Here, L represents a range of values (value range width) that can be taken by each component.

On the basis of the importance of information Zᵢ thus obtained, the global determination unit 232 determines one input as the global candidate point from an input group (input Xᵢ, i=1 to N or the like) for which Zᵢ is obtained (step S106). At that time, the global determination unit 232 makes the adoption probability of each combination (input Xᵢ) proportional to the importance of information Zᵢ.

Note that, if an additional search for the input Xᵢ of which the characteristic value to be optimized or its predicted value (the above expected value Eᵢ) is small is not requested including its neighborhood, the global determination unit 232 may make the importance of information Zᵢ zero or invalid, or the like to exclude it from options of the global candidate points. For example, the global determination unit 232 may set a threshold value (a lower limit value E0 of the expected value as the global candidate point) for the expected value Eᵢ and exclude Xᵢ that satisfies Eᵢ<E0 from the options.

In addition, the global determination unit 232 may also set a threshold value for the number of experiments Nᵢ for a specific combination or the uncertainty Aᵢ (an upper limit value N0 or A0 as a global candidate point), and exclude the Xᵢ from the options when they exceed the respective threshold values, that is, when Nᵢ>N0 or Aᵢ>A0.

By adding such an exclusion process, although the accuracy of peak height measurement lowers, the search can be speeded up. Note that, the above exclusion process can also be performed by the detail determination unit 233 described later.

The global determination unit 232 does not select based on max importance of information Zᵢ, but determines the global candidate point by randomization proportional to importance of information Zᵢ, whereby resistance to measurement noise is obtained, and it is possible to avoid that the search is performed only for a specific peak.

When the global candidate point is determined, the detail determination unit 233 adds a random vector to the global candidate point to generate candidates for the input (combination) of the next experiment (step S107). The detail determination unit 233 generates a plurality of input candidates Xᵢ′ for the next experiment by adding a random number of about 0.1 L to each component of the input as the global candidate point, for example.

Then, the detail determination unit 233 obtains the importance of information Zᵢ′ for each of the generated input candidates Xᵢ′, and determines the input candidate having the highest importance of information Zᵢ′ as the input to be subjected to the experiment next (step S108, step S109). Here, the importance of information Zᵢ′ for the input candidate can be calculated by using kernel regression or Gaussian process regression based on the experimental results so far. By narrowing the combinations to be subjected to the experiment next to the vicinity of the global candidate point, it is not necessary to calculate the importance of information for all combination candidates, so that the detail determination unit 233 also can reduce the calculation cost. Note that, instead of the algorithm described above, the detail determination unit 233 can also use an algorithm in which the ones obtained by adding the random vector to the global candidate point are used as they are, or random selection is performed from the ones obtained by adding the random vector to the global candidate point, or an input candidate having the highest uncertainty Aᵢ is selected. Although the prediction accuracy is reduced, the calculation cost can be reduced. Note that, in addition to this, the selection algorithm in the detail determination unit 233 can also adopt an input candidate having the highest expected value Eᵢ from the ones obtained by adding the random vector to the global candidate point.

When the combination to be subjected to the experiment next is determined, the search unit 20 outputs the information (step S110).

When the information on the combination to be subjected to the experiment next is input, the experiment unit 30 performs the experiment by using the combination, and adds the result to the storage unit 10 (step S111).

When the experimental result for the determined combination is obtained, the end decision unit 22 decides whether or not the experimental results obtained so far or the search progress so far satisfies the end condition of the search (step S112). When the end condition of the search is satisfied (Yes in step S112), the process is ended. On the other hand, when the end condition of the search is not satisfied (No in step S112), the process returns to step S111.

As described above, according to the present exemplary embodiment, while the combination to be preferentially measured is determined at high speed, even when the characteristic to be optimized have peaks in a plurality of different combinations, it is possible to obtain a combination as an appropriate solution at high speed and stably. Here, the appropriate solution depends on the end condition of the search, but examples thereof include a solution satisfying a predetermined comprehensiveness in compatibility with the cost to obtain the solution, a solution corresponding to two or more peaks, and the like.

Note that, in the above, an optimization method has been described in which optimization is performed by repeatedly performing a process of determining one combination in one search determination process and of obtaining the experimental result each time one combination is determined; however, for example, a method is possible of determining a plurality of combinations in one search determination process, performing an experiment for each of them, and returning again to the search determination process once the results are reflected. In that case, for example, the global determination unit 232 may determine two or more global candidate points by using the importance as the adoption probability, the detail determination unit 233 may determine two or more combinations for the determined global candidate point on the basis of the importance, or it is also possible to combine them.

Hereinafter, the effects of the present exemplary embodiment will be described by using a specific example. In the following, as a combination problem as an application target of the present invention, a problem is exemplified of solving a composition ratio of a multidimensional material; however, in addition to that, the present invention can be similarly applied to a problem for which the result can be predicted by using the prediction unit 231, that is, a problem for which the result for an unknown combination can be predicted from the past results.

### EXAMPLE 1

FIG. 5A is a graph illustrating output of a function F(x, y) of an optimization problem of a binary combination that is a first example. The function F is defined in a two-dimensional space, and the output changes depending on the two parameters x and y as illustrated in FIG. 5A. FIG. 5B is a schematic diagram schematically illustrating a plurality of peaks illustrated in FIG. 5A. Here, the function F is defined as the equation (4) for the two parameters x and y.

$$\begin{matrix} [ Mathematical Expression 4 ] & \\ F ( x , y ) = 1.2 * exp ( 0.04 * ( {( x - 20 )}^{2} + {( y - 20 )}^{2} ) + 0.8 * exp ( 0.04 * ( {( x - 40 )}^{2} + {( y - 70 )}^{2} ) + 0.6 * exp ( 0.04 * ( {( x - 100 )}^{2} + {( y - 50 )}^{2} ) - 0.6 * exp ( 0.01 * ( {( x - 30 )}^{2} + {( y - 30 )}^{2} ) & ( 4 )\end{matrix}$$

As illustrated in FIGS. 5(a) and 5(b), the function F(x, y) of the present example has a negative peak at (30, 30), and has positive peaks at (20, 20), (40, 70), and (100, 50). Hereinafter, as illustrated in FIG. 5B, the negative peak of (30, 30) is denoted as P0, and the positive peaks of (20, 20), (40, 70), and (100, 50) are denoted as P1, P2, and P3, respectively. In the present example, the peak P0 interferes with finding of the peak P1. Further, the peak P3 has a wide peak width, and functions as a local solution.

In such a case, searching for a combination of x and y in which F(x, y) has a large value is considered.

Note that, the function F(x, y) illustrated in FIGS. 5A and 5B is a hypothetical function, but even in the combination problem of the composition ratio of raw materials of a material, there is a case where such a plurality of positive peaks, or a negative peak caused by destruction, oxidation, or the like of the material.

FIGS. 6 to 9 are schematic diagrams illustrating results of searching for a combination of parameters x and y for the function F by different optimization methods. In the figure, thick circles represent points (output points) that are output as a combination for which an experiment should be performed. If an output point is inside a black circle indicating a positive peak, then that peak has been found. Note that, in FIGS. 6 to 9, the experiment (in the case of the present example, calculation of the measured value) is performed 100 times each.

FIG. 6 illustrates a result of searching a combination (x, y) that optimizes the function F(x, y) with the method described in NPL 1. As illustrated in FIG. 6, with the method, the peak P3 can be found, but no other peak can be found. As described above, with the method described in NPL 1, it can be seen that search is trapped by the peak P3 that is a local solution, and other peaks are not searched for.

FIG. 7 is a schematic diagram illustrating a result of searching for a combination of x and y by the strategy determination unit 21 by the above method in which the randomized method and the two-stage search method are combined. As illustrated in FIG. 7, it can be seen that all peaks can be found by the method.

FIG. 8 is a schematic diagram illustrating search results when the randomized method is omitted and only the two-stage search method is used. As illustrated in FIG. 8, it can be seen that the peak P2 and the peak P3 can be found but the peak P1 cannot be found with the method. It is presumed that this is because the valley of the peak P0 cannot be crossed and the number of experiments near the peak P1 is reduced, and as a result, the point near the peak P1 is less likely to be selected as the global candidate point.

FIG. 9 is a schematic diagram illustrating search results when the global determination unit 232 selects an input having the highest importance of information as a global candidate point and performs the two-stage search method. In the method, the search in the vicinity of the peak P2 previously found is prioritized too much, and the peak P1 cannot be found.

Note that, although not verified by the function F( ), it is considered that in the case of the method described in PTL 2, even if the peak P2 and the peak P3 can be found by using a plurality of agents, the valley of the peak P0 cannot be crossed, and it is difficult to find the peak P1. Not only that, it is expected that reduction of efficiency occurs due to that the agent experiments with the same peak multiple times.

In the case of the method described in PTL 3, since statistics are predicted from past experimental results, it is expected that duplication of experiments can be avoided to some extent. However, since the combination is optimized by the hill-climbing method, it is considered that the valley of the peak P0 cannot be crossed, and it is difficult to find the peak P1, as in the method described in PTL 2.

In addition, in the case of the method described in NPL 2, although the calculation cost until combination determination can be suppressed, the combination to be measured next is given by crossing the excellent combinations, so that the diversity of the combinations cannot be managed, and search is trapped by the peak P3 that is a local solution, and it is expected that other peaks are not searched for.

In addition, FIG. 10 is an explanatory diagram illustrating a result of cost comparison between the two-stage search method according to the present invention and other methods (full search and the method described in NPL 1). Note that when the cost illustrated in FIG. 10 is calculated, the trap of the local solution and the hindrance of the search by the valley are ignored. Here, a cost of the combination determination means specifically the amount of calculation required to determine one combination to be subjected to the experiment next from the past experimental results. A cost of the one peak finding means the number of experiments required to find one peak. A cost of the K peaks finding means the number of experiments required to find K peaks.

In FIG. 10, d is the number of parameters, that is, the number of dimensions of the combination. The degree of freedom of each parameter of the combination is f. P is the number of sample data. The width of the peak is w, m is the number of experiments required to determine the apex of each peak, M is the number of experiments required to set the experiment priority (importance of information) of the combinations that forms one peak to 0. The value of each cost in FIG. 10 is calculated as d=2, f=100, w to 10, m to 10, and M to 40.

As illustrated in FIG. 10, if the two-stage search method according to the present invention is used, the cost of the K peaks finding can be reduced, which is particularly effective for a problem in which one experiment takes time. In addition, from the cost illustrated in FIG. 10, the two-stage search method according to the present invention can be applied even in a high dimension (in particular, five dimensions or more) that cannot be handled by the conventional methods. For example, substituting d=5, f=100, w to 10, m to 10, and M to 40 in the cost calculation formula of each method in FIG. 10, the calculation cost has an order of 10 to the 10th power with the method disclosed in NPL 1, but the order can be suppressed to about 10 to the 5th power with the method of the present invention.

### EXAMPLE 2

Next, an optimization result will be described of the synthesis ratio of each material of the Heusler alloy (Fe₂₋ₓCoₓCr_{1-y}Mn_{y}Si_{1-z-a}Al_{z}Geₐ) with the spin polarization as the objective variable using the optimization method of the present invention. Here, there are a total of four combination parameters, namely, a ratio x of Co, a ratio y of Mn, a ratio z of Al, and a ratio a of Ge in the Heusler alloy.

FIG. 11 is a graph illustrating experimental results in a second example. FIG. 11 illustrates fluctuation in spin polarization obtained by sequentially performing experiments (numerical calculation) for each of the inputs (composition ratios) identified by the experiment numbers determined by the method illustrated in FIG. 3. In the present example, from a state in which information indicating a result of an experiment conducted for one combination randomly determined first is stored in the storage unit 10, inputs of the combination of the above four parameters are sequentially determine by using the method illustrated in FIG. 3, and each time one input is determined, an experiment (numerical calculation) is performed on the material indicated by the input, and the result is reflected in the storage unit 10. Determination of the input and the experiment are performed until the end condition of 100 times is satisfied.

Note that, from the experimental results, the area having high spin polarization (the area where the combination of the experimental results surrounded by the broken line in FIG. 11 is located) is scattered in three places of Co₂Cr_{0.6}Mn_{0.5}Al, Fe_{0.6}Co_{1.4}Cr_{0.3}Mn_{0.7}Si_{0.3}Al_{0.6}Ge_{0.1}, and Fe_{1.2}Co_{0.8}MnSi_{0.3}Al_{0.4}Ge_{0.3}. When indicated as a combination of parameters, this is (x, y, z, a)=(2.0, 0.5, 1.0, 0), (1.4, 0.7, 0.6, 0.1), (0.8, 1.0, 0.4, 0.3). Note that, the first found peak is (1.4, 0.7, 0.6, 0.1).

FIG. 12 is a graph illustrating a distribution of the number of experiments for each synthesis ratio of Fe in the second example. In the method described in NPL 1, and the like, only the composition ratio (Fe 60%) in the vicinity of the peak found first is measured, and the presence of other peaks is overlooked, whereas in the above method, a plurality of peaks can be found.

### [Others]

For example, the combination search method of the present exemplary embodiment can be used for optimizing arbitrary multidimensional function other than materials. In particular, in a problem (for example, overlearning) in which there is a discontinuous change or a valley near the peak, it is difficult to cross the valley by the hill-climbing method or the method in which the agent is moved, whereas the combination search method of the present exemplary embodiment includes appropriate randomization, so that it is possible to optimize the problem in which there is a discontinuous change or a valley near the peak. Here, the appropriate randomization includes not only randomization by the randomization unit 24 but also randomization using the importance of information by the global determination unit 232 as the adoption probability.

In addition, the combination search method of the present exemplary embodiment can also be used for a problem in which inputs and outputs take discrete values. For example, an optimization problem of transportation infrastructure is considered. When a place where a road is constructed is an input and a physical distribution brought by the road is an output, the input and the output have discrete values. The combination search method of the present exemplary embodiment can perform high speed and stable optimization on such a problem if it is possible to predict an output for an unknown input from a set of the past input and output (a known method such as kernel approximation or Gaussian process regression can be used). Compared to the genetic algorithm known as an optimization method for discrete inputs, the combination search method of the present exemplary embodiment is less likely to be trapped by a local solution, and duplication of experiments can be easily avoided.

In addition, the combination search method of the present exemplary embodiment can also be used for a problem in which an output has an error. For example, in AI that plays poker, setting a value of each card in advance and leaving a high-value hand are considered. To create a stronger AI, it is necessary to solve a multidimensional optimization problem in which a set of card values is used as an input and the final profit when the AI is actually played is used as an output. In this case, a statistical error is added to the output. In the case of a method that does not consider the error (for example, the methods described in NPL 1, PTLs 1 to 3, and the like), the experiment concentrates around the input in which a high output is obtained by accident, but in the case of the present method, the noise of the output can be avoided by the variance of the experiments by the strategy determination unit 21 and the global determination unit 232.

In addition, FIG. 13 is a schematic block diagram illustrating a configuration example of a computer according to each exemplary embodiment of the present invention. A computer 1000 includes a CPU 1001, a main storage device 1002, an auxiliary storage device 1003, an interface 1004, a display device 1005, and an input device 1006.

The device and the like included in the combination search system of the exemplary embodiment described above may be installed in the computer 1000. In that case, operation of each device may be stored in the auxiliary storage device 1003 in the form of a program. The CPU 1001 reads the program from the auxiliary storage device 1003, and deploys the program on the main storage 1002, and then implements predetermined processing in each exemplary embodiment in accordance with the program. Note that, the CPU 1001 is an example of an information processing device that operates in accordance with a program, and may include, in addition to a Central Processing Unit (CPU), for example, a Micro Processing Unit (MPU), a Memory Control Unit (MCU), a Graphics Processing Unit (GPU), or the like.

The auxiliary storagee 1003 is an example of a non-transitory tangible medium. Other examples of the non-transitory tangible medium include a semiconductor memory, DVD-ROM, CD-ROM, a magneto-optical disk, and a magnetic disk connected via the interface 1004. In addition, when the program is delivered to the computer 1000 via a communication line, the computer 1000 to which the program is delivered may deploy the program on the main storage 1002 to execute the predetermined processing in each exemplary embodiment.

In addition, the program may be for realizing a part of predetermined processing in the above exemplary embodiment. Further, the program may be a differential program that realizes the predetermined processing in each exemplary embodiment in combination with another program already stored in the auxiliary storage 1003.

The interface 1004 exchanges information with other devices. In addition, the display 1005 presents information to a user. In addition, the input device 1006 receives input of information from the user.

In addition, depending on processing contents in the exemplary embodiment, some elements of the computer 1000 can be omitted. For example, if the computer 1000 does not present information to the user, the display 1005 can be omitted. For example, if the computer 1000 does not receive information input from the user, the input device 1006 can be omitted.

In addition, some or all of the constituent elements of the above exemplary embodiment are implemented by general purpose or dedicated circuitry, a processor, or the like, or a combination thereof. These may be configured by a single chip or may be configured by a plurality of chips connected together via a bus. In addition, some or all of the constituent elements of the above exemplary embodiment may be realized by a combination of the program and the circuitry and the like described above.

When some or all of the constituent elements of the above exemplary embodiment are realized by a plurality of information processing devices, the circuitry, and the like, the plurality of information processing devices, the circuitry, and the like may be centrally arranged, or may be arranged in a distributed manner. For example, the information processing device, the circuitry, and the like may be realized by being connected together via a communication network, such as a client and server system and a cloud computing system.

Next, an outline of the present invention will be described. FIG. 14 is a block diagram illustrating an outline of a combination search system of the present invention. A combination search system 600 illustrated in FIG. 14 includes a storage 61 and a search unit 62.

The storage 61 (for example, the storage unit 10) stores information that is actual data in a multidimensional combination problem for a predetermined parameter accompanied by a predetermined confirmation work and in which input information indicating a combination of values taken by elements of the multi dimensions in the past in the confirmation work or in a real space is associated with output information indicating a value of the predetermined parameter obtained for the combination indicated by the input information at that time.

The search unit 62 (for example, the search unit 20) repeats, until a predetermined end condition is satisfied, a process of determining at least one combination to be used in next confirmation work on the basis of importance of information that is an index defined for each combination of the elements of the multi dimensions, the index being calculated from the actual data and being defined on the basis of an amount of change in uncertainty of the value of the predetermined parameter in the whole of a search space due to that new output information for the combination is added to the actual data.

With such a configuration, it is possible to efficiently and stably search for an appropriate solution even in the case of having a plurality of peaks.

In addition, FIG. 15 is a block diagram illustrating another example of the combination search system of the present invention. As illustrated in FIG. 15, in the combination search system 600 of the present invention, the search unit 62 may include a global determination unit 621 and a detail determination unit 622.

The global determination unit 621 (for example, the global determination unit 232) performs narrowing down to the combination to be used in the next confirmation work on the basis of the importance of information calculated for some combinations included in the search space. The global determination unit 621 may perform narrowing down to the combination to be used in the next confirmation work by adopting one or a plurality of the combinations from the some combinations on the basis of the importance of information.

The detail determination unit 622 (for example, the detail determination unit 233) determines the combination to be used in the next confirmation work on the basis of the narrowing-down result by the global determination unit 621. The detail determination unit 622 may determine the combination to be used in the next confirmation work by searching a subspace of the search space with the combination adopted by the global determination unit 621 as a starting point.

With the configuration in which the detail determination unit 622 determines the combination to be used in the next confirmation work after performing the narrowing down by the global determination unit 621, solutions corresponding to a plurality of peaks can be obtained at high speed, for example.

Note that, the above exemplary embodiment can be described also as the following supplementary notes.

(Supplementary note 1) A combination search system including: a storage unit that stores information that is actual data in a multidimensional combination problem for a predetermined parameter accompanied by predetermined confirmation work and in which input information indicating a combination of values taken by elements of the multi dimensions in the past in the confirmation work or in a real space is associated with output information indicating a value of the predetermined parameter obtained for the combination indicated by the input information at that time; and a search unit that repeats, until a predetermined end condition is satisfied, a process of determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

(Supplementary note 2) The combination search system according to supplementary note 1, in which the search unit includes a global determination unit that performs narrowing down to the combination to be used in the next confirmation work on the basis of the importance of information calculated for some combinations included in the search space.

(Supplementary note 3) The combination search system according to supplementary note 2, in which the global determination unit calculates the importance of information for, as the some combinations, combinations of the elements indicated by the input information included in the actual data.

(Supplementary note 4) The combination search system according to supplementary note 2 or 3, in which the global determination unit performs narrowing down to the combination to be used in the next confirmation work by adopting one or a plurality of the combinations from the some combinations on the basis of the importance of information.

(Supplementary note 5) The combination search system according to any of supplementary notes 2 to 4, in which the global determination unit performs narrowing down to the combination to be used in the next confirmation work by adopting one combination as a search starting point of the combination to be used in the next confirmation work, from the some combinations, with a probability proportional to the importance of information.

(Supplementary note 6) The combination search system according to supplementary note 4 or 5, in which the search unit includes a detail determination unit that determines the combination to be used in the next confirmation work by searching a subspace of the search space with the combination adopted by the global determination unit as a starting point.

(Supplementary note 7) The combination search system according to any of supplementary notes 1 to 6, in which the search unit determines, as the combination to be used in the next confirmation work, a combination randomly adopted from the search space, with a certain probability.

(Supplementary note 8) The combination search system according to any of supplementary notes 1 to 7, in which the importance of information is an index calculated from the actual data and based on a reduction degree of uncertainty of a predicted value of the predetermined parameter in the whole of the search space due to that new output information for the combination is added to the actual data.

(Supplementary note 9) The combination search system according to any of supplementary notes 1 to 7, in which the importance of information is an index calculated on the basis of an expected value of the predetermined parameter for the combination calculated by regression analysis from the actual data and uncertainty of the expected value, and based on a reduction degree of a variance of the expected value in the whole of the search space.

(Supplementary note 10) The combination search system according to any of supplementary notes 1 to 9, in which when importance of information for a certain combination i is Zᵢ, and an expected value of the predetermined parameter for the combination calculated by regression analysis from the actual data is Eᵢ, and uncertainty of the expected value is Aᵢ, importance of information for an arbitrary combination is given by a function satisfying that the function converges to 0 when Eᵢ has a minimum value or Aᵢ is 0, and that Zᵢ≤Zⱼ when Aᵢ≤Aⱼ and Eᵢ≤Eⱼ for arbitrary i, j.

(Supplementary note 11) The combination search system according to any of supplementary notes 1 to 10, further including an output unit that outputs information indicating the combination to be used in the next confirmation work, and an input unit that adds new actual data to the storage unit.

(Supplementary note 12) The combination search system according to supplementary note 11, further including a predetermined device that performs confirmation work, in which the output unit gives, to the predetermined device, information indicating the combination to be used in the next confirmation work, and an instruction for confirmation work using the combination, and the input unit adds new actual data to the storage unit when receiving information indicating a result of the confirmation work from the predetermined device.

(Supplementary note 13) The combination search system according to any of supplementary notes 1 to 12, in which the predetermined end condition is defined by using at least one of the value of the predetermined parameter confirmed, a number of combinations to be a solution, the uncertainty, or a number of times of the confirmation work.

(Supplementary note 14) The combination search system according to any of supplementary notes 1 to 13, in which the multidimensional combination problem is any of a combination problem of condition parameters for material synthesis for a predetermined characteristic, a combination problem of input parameters for an output value of a multidimensional function, a multidimensional combination problem including elements taking discrete values, a multidimensional combination problem for parameters whose measured values include noise, or a combination problem for data subjected to dimension reduction for predetermined identification.

(Supplementary note 15) An information processing device accessible to a storage unit that stores information that is actual data in a multidimensional combination problem for a predetermined parameter accompanied by predetermined confirmation work and in which input information indicating a combination of values taken by elements of the multi dimensions in the past in the confirmation work or in a real space is associated with output information indicating a value of the predetermined parameter obtained for the combination indicated by the input information at that time, the information processing device including a search unit that repeats, until a predetermined end condition is satisfied, a process of determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

(Supplementary note 16) A combination search method including repeating a process by an information processing device until a predetermined end condition is satisfied, the information processing device being accessible to a storage unit that stores information that is actual data in a multidimensional combination problem for a predetermined parameter accompanied by predetermined confirmation work and in which input information indicating a combination of values taken by elements of the multi dimensions in the past in the confirmation work or in a real space is associated with output information indicating a value of the predetermined parameter obtained for the combination indicated by the input information at that time, the process determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

(Supplementary note 17) A combination search program for causing a computer to execute a process repeatedly until a predetermined end condition is satisfied, the computer being accessible to a storage unit that stores information that is actual data in a multidimensional combination problem for a predetermined parameter accompanied by predetermined confirmation work and in which input information indicating a combination of values taken by elements of the multi dimensions in the past in the confirmation work or in a real space is associated with output information indicating a value of the predetermined parameter obtained for the combination indicated by the input information at that time, the process determining at least one combination to be used in next confirmation work on the basis of importance of information that is an index defined for each combination of the elements, the index being calculated from the actual data and being defined on the basis of an amount of change in uncertainty of the value of the predetermined parameter in the whole of a search space due to that new output information for the combination is added to the actual data.

In the above, the present invention has been described with reference to the present exemplary embodiment and examples; however, the present invention is not limited to the exemplary embodiment and examples described above. Various modifications that can be understood by those skilled in the art within the scope of the present invention can be made to the configuration and details of the present invention.

This application claims priority based on Japanese Patent Application No. 2018-055494 filed on Mar. 23, 2018, the disclosure of which is incorporated herein in its entirety.

### INDUSTRIAL APPLICABILITY

The present invention is suitably applicable not only to a multidimensional combination problem having a plurality of peaks, but also to an application for performing optimization to a multidimensional combination problem involving a relatively high cost to obtain an experimental result and the like, or a multidimensional combination problem involving an error in output.

### REFERENCE SIGNS LIST

10 Storage unit
20 Search unit
21 Strategy determination unit
22 End decision unit
23 Two-stage determination unit
231 Prediction unit
232 Global determination unit
233 Detail determination unit
24 Randomization unit
30 Experiment unit
600 Combination search system
61 Storage
62 Search unit
621 Global determination unit
622 Detail determination unit
1000 Computer
1001 CPU
1002 Main storage
1003 Auxiliary storage
1004 Interface
1005 Display
1006 Input device

1. A combination search system comprising:
a storage that stores information that is actual data in a multidimensional combination problem for a predetermined parameter accompanied by predetermined confirmation work and in which input information indicating a combination of values taken by elements of the multi dimensions in a past in the confirmation work or in a real space is associated with output information indicating a value of the predetermined parameter obtained for the combination indicated by the input information at that time; and
a search unit, implemented by a hardware including at least one processor, that repeats, until a predetermined end condition is satisfied, a process of determining at least one combination to be used in next confirmation work on a basis of importance of information that is an index defined for each combination of the elements, the index being calculated from the actual data and being defined on a basis of an amount of change in uncertainty of the value of the predetermined parameter in a whole of a search space due to that new output information for the combination is added to the actual data.

2. The combination search system according to claim 1, wherein
the search unit includes
a global determination unit that performs narrowing down to the combination to be used in the next confirmation work on the basis of the importance of information calculated for some combinations included in the search space.

3. The combination search system according to claim 2, wherein
the global determination unit calculates the importance of information for, as the some combinations, combinations of the elements indicated by the input information included in the actual data.

4. The combination search system according to claim 2, wherein
the global determination unit performs narrowing down to the combination to be used in the next confirmation work by adopting one or a plurality of the combinations from the some combinations on the basis of the importance of information.

5. The combination search system according to claim 2, wherein
the global determination unit performs narrowing down to the combination to be used in the next confirmation work by adopting one combination as a search starting point of the combination to be used in the next confirmation work, from the some combinations, with a probability proportional to the importance of information.

6. The combination search system according to claim 4, wherein
the search unit includes
a detail determination unit that determines the combination to be used in the next confirmation work by searching a subspace of the search space with the combination adopted by the global determination unit as a starting point.

7. The combination search system according to claim 1, wherein
the search unit determines, as the combination to be used in the next confirmation work, a combination randomly adopted from the search space, with a certain probability.

8. The combination search system according to claim 1, wherein
the importance of information is an index calculated from the actual data and based on a reduction degree of uncertainty of a predicted value of the predetermined parameter in the whole of the search space due to that new output information for the combination is added to the actual data.

9. The combination search system according to claim 1, wherein
the importance of information is an index calculated on a basis of an expected value of the predetermined parameter for the combination calculated by regression analysis from the actual data and uncertainty of the expected value, and based on a reduction degree of a variance of the expected value in the whole of the search space.

10. The combination search system according to claim 1, wherein
when importance of information for a certain combination i is and an expected value of the predetermined parameter for the combination calculated by regression analysis from the actual data is Eᵢ, and uncertainty of the expected value is Aᵢ, importance of information for an arbitrary combination is given by a function satisfying that the function converges to 0 when Eᵢ has a minimum value or Aᵢ is 0, and that Zᵢ≤Zⱼ when Aᵢ≤Aⱼ and Eᵢ≤Eⱼ for arbitrary i, j.

11. The combination search system according to claim 1, further comprising
an output unit that outputs information indicating the combination to be used in the next confirmation work, and
an input unit that adds new actual data to the storage.

12. The combination search system according to claim 11, further comprising
a predetermined device that performs confirmation work, wherein
the output unit gives, to the predetermined device, information indicating the combination to be used in the next confirmation work, and an instruction for confirmation work using the combination, and
the input unit adds new actual data to the storage when receiving information indicating a result of the confirmation work from the predetermined device.

13. The combination search system according to claim 1, wherein
the predetermined end condition is defined by using at least one of the value of the predetermined parameter confirmed, a number of combinations to be a solution, the uncertainty, or a number of times of the confirmation work.

14. The combination search system according to claim 1, wherein
the multidimensional combination problem is any of a combination problem of condition parameters for material synthesis for a predetermined characteristic, a combination problem of input parameters for an output value of a multidimensional function, a multidimensional combination problem including elements taking discrete values, a multidimensional combination problem for parameters whose measured values include noise, or a combination problem for data subjected to dimension reduction for predetermined identification.

15. (canceled)

16. A combination search method, implemented by at least one processor, comprising
repeating a process by an information processing device until a predetermined end condition is satisfied, the information processing device being accessible to a storage that stores information that is actual data in a multidimensional combination problem for a predetermined parameter accompanied by predetermined confirmation work and in which input information indicating a combination of values taken by elements of the multi dimensions in a past in the confirmation work or in a real space is associated with output information indicating a value of the predetermined parameter obtained for the combination indicated by the input information at that time, the process determining at least one combination to be used in next confirmation work on a basis of importance of information that is an index defined for each combination of the elements, the index being calculated from the actual data and being defined on a basis of an amount of change in uncertainty of the value of the predetermined parameter in a whole of a search space due to that new output information for the combination is added to the actual data.

17. A non-transitory computer readable information recording medium storing a combination search program for causing a computer to execute a process repeatedly until a predetermined end condition is satisfied,
the computer being accessible to a storage that stores information that is actual data in a multidimensional combination problem for a predetermined parameter accompanied by predetermined confirmation work and in which input information indicating a combination of values taken by elements of the multi dimensions in a past in the confirmation work or in a real space is associated with output information indicating a value of the predetermined parameter obtained for the combination indicated by the input information at that time,
the process determining at least one combination to be used in next confirmation work on a basis of importance of information that is an index defined for each combination of the elements, the index being calculated from the actual data and being defined on a basis of an amount of change in uncertainty of the value of the predetermined parameter in a whole of a search space due to that new output information for the combination is added to the actual data.

18. The combination search system according to claim 3, wherein
the global determination unit performs narrowing down to the combination to be used in the next confirmation work by adopting one or a plurality of the combinations from the some combinations on the basis of the importance of information.

19. The combination search system according to claim 3, wherein
the global determination unit performs narrowing down to the combination to be used in the next confirmation work by adopting one combination as a search starting point of the combination to be used in the next confirmation work, from the some combinations, with a probability proportional to the importance of information.

20. The combination search system according to claim 18, wherein
the search unit includes
a detail determination unit that determines the combination to be used in the next confirmation work by searching a subspace of the search space with the combination adopted by the global determination unit as a starting point.

21. The combination search system according to claim 19, wherein
the search unit includes
a detail determination unit that determines the combination to be used in the next confirmation work by searching a subspace of the search space with the combination adopted by the global determination unit as a starting point.
